(19) United States
(12) Patent Application Publication
(10) Pub. No.: US 2026/0166518 A1
(43) Pub. Date: Jun. 18, 2026

(54) ABSORPTION DEVICES, MATERIALS, AND METHODS

(71) Applicants: Celgard, LLC, Charlotte, NC (US); DARAMIC, LLC, Charlotte, NC (US)

(72) Inventors: Chad Graves, Owensboro, KY (US); Andrew Goodby, Owensboro, KY (US); Celine Chan, Fort Mill, SC (US); J. Kevin Whear, Utica, KY (US); Matt Wolski, Charlotte, NC (US); Margaret Roberts, Owensboro, KY (US); Daniel R. Alexander, Matthews, NC (US)

(21) Appl. No.: 18/998,514

(22) PCT Filed: Aug. 1, 2023
(86) PCT No.: PCT/US2023/029172

§ 371 Date: Jan. 26, 2025

Related U.S. Application Data
(60) Provisional application No. 63/394,522, filed on Aug. 2, 2022.

(51) Int. Cl. B01J 20/26; A47G 27/02; A47L 13/16; A47L 23/26; B01J 20/28; B32B 27/08; B32B 27/20; B32B 27/22; B32B 27/32; C02F 1/28; C02F 1/40; C02F 101/32; C09K 3/32

(52) U.S. Cl. CPC B01J 20/261; A47G 27/0231; A47L 13/16; A47L 23/266; B01J 20/28004; B01J 20/28035; B01J 20/2804; B32B 27/08; B32B 27/20; B32B 27/22; B32B 27/32; C02F 1/285; C02F 1/288; C02F 1/40; C09K 3/32; B32B 2250/02; B32B 2250/242; B32B 2264/1021; B32B 2272/00; B32B 2307/21; B32B 2307/714; B32B 2307/726; B32B 2307/7376; B32B 2307/744; B32B 2432/00; B32B 2471/04; C02F 2101/32

(57) ABSTRACT

In one aspect, a device for absorbing a liquid is provided, the device comprising one or more layers of a polyolefin. The device may be configured as a microporous membrane comprising one or more layers of a polyolefin and can further be configured to absorb an oil while also allowing water to pass through or to absorb oil while repelling or not allowing water to pass through. The device may be configured as at least one of a sheet, a strip, a roll, pleated, embossed, ribbed, and patterned. The device may further be configured as a floor covering or mat.

### RELATED APPLICATION DATA

This application is a 371 US. application which claims priority to PCT Application No. PCT/US2023/029172, filed Aug. 1, 2023, which claims priority to U.S. Provisional Application No. 63/394,522, filed Aug. 2, 2022, and is incorporated herein in its entirety.

### FIELD

The technology described herein generally relates to absorption devices, materials, and methods, including films, thin films, and/or membranes, and more specifically to microporous membranes and devices having absorptive properties, especially oil absorbing devices and materials such as polyolefin membranes with or without silica fillers, and composite membranes such as dry process PP membranes and wet process PE silica filled membranes.

### BACKGROUND

Microporous membranes or thin films find a variety of applications because of their intrinsic porous characteristics, versatile chemical and structural compositions, and wide array of functionality.

Oil in industrial environments, as a component in pollution, in a laboratory, and in the household can be a nuisance and can further be difficult to remove in many instances from other surfaces, or for example when mixed with other liquids such as water.

Accordingly, there is a need for improved membranes and/or films that exhibit higher performance absorption characteristics, for example provide higher oil absorption and collection capabilities as well as provide some chemical stability, and additionally impart improved safety features over conventional oil removal devices and methods.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the technology described herein are directed towards films and/or thin films, more specifically towards microporous membranes which can be constructed from one or more layers of a polyolefin and implemented and/or formed into an absorptive device.

According to some embodiments, an absorption device is provided, the device comprising a microporous membrane comprising one or more layers of a polyolefin, wherein the microporous membrane is configured to absorb an oil.

In some further embodiments an absorption device can be formed into a sheet, strip, roll, amongst other configurations, and can incorporate structural elements such as pleats, ribs, embossing, raised shapes, suction elements, embossing, and patterning.

In some other embodiments, an absorption device can comprise a microporous membrane and be implemented for absorbing oil, adsorbing oil, or otherwise removing oil from a surface or another liquid.

In some even further embodiments, an absorption device comprising a microporous membrane can be formed into a floor covering or mat.

Additional objects, advantages, and novel features of the invention will be set forth in part in the description which follows, and in part will become apparent to those skilled in the art upon examination of the following, or can be learned by practice of the invention.

### BRIEF DESCRIPTION OF THE DRAWINGS

Aspects of the technology presented herein are described in detail below with reference to the accompanying drawing figures, wherein:

FIG. 1 illustrates various aspects of an oil absorption device, in accordance with some embodiments of the technology described herein; and

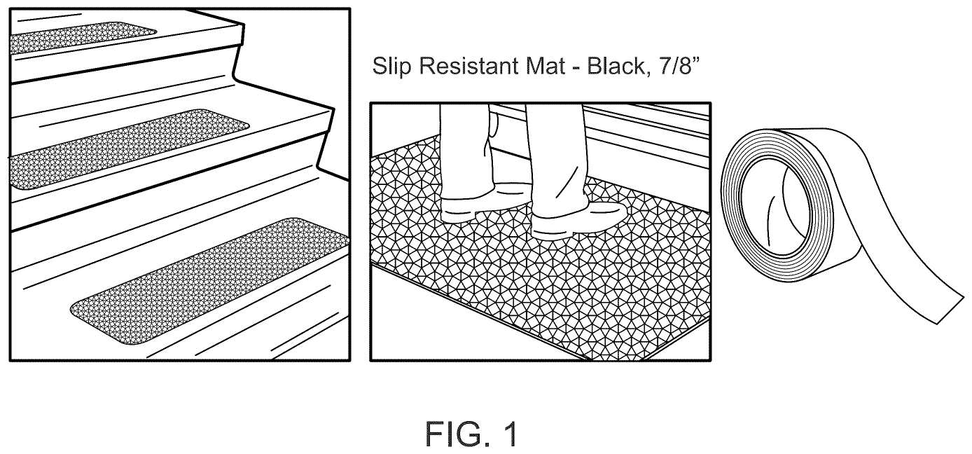

FIG. 2 illustrates various aspects of an oil absorption device, in accordance with some embodiments of the technology described herein. and

FIG. 3 illustrates a membrane on the floor of a laboratory where oxidative chemicals can potentially be spilled from Day 1 through Day 14 and Day 28 up to Day 42; and

FIG. 4 illustrates a membrane on the floor in a heavy traffic area of an industrial plant where exposure to oil and dirt is possible from Day 1 through Day 14 and Day 28 up to Day 42;

FIG. 5 illustrates a membrane's condition after 9 months of use in a laboratory where oxidative chemicals could potentially be spilled; and

FIG. 6 is a graphical representation of increased oil pickup by adding one or more layers of a dry process PP membrane to one or more layers of a wet process PE silica filled membrane.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps disclosed herein unless and except when the order of individual steps is explicitly described.

Embodiments described herein can be understood more readily by reference to the following detailed description, examples, and figures. Elements, apparatus, and methods described herein, however, are not limited to the specific embodiments presented in the detailed description, examples, and figures. It should be recognized that the exemplary embodiments herein are merely illustrative of the principles of the invention. Numerous modifications and adaptations will be readily apparent to those of skill in the art without departing from the spirit and scope of the invention.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” or “5 to 10” or “5-10” should generally be considered to include the end points 5 and 10.

Further, when the phrase “up to” is used in connection with an amount or quantity; it is to be understood that the amount is at least a detectable amount or quantity. For example, a material present in an amount “up to” a specified amount can be present from a detectable amount and up to and including the specified amount.

Additionally, in any disclosed embodiment, the terms “substantially,” “approximately,” and “about” may be substituted with “within [a percentage] of” what is specified, where the percentage includes 0.1, 1, 5, and 10 percent.

Films, thin films, or microporous membranes have a variety of applications to perform a variety of functions, and further can be formed into or incorporated into a variety of devices, which take advantage of various properties of such microporous membrane material. According to aspects of the technology described herein, a microporous membrane may be formed into a device for absorbing one or more liquids, for example an oil, while allowing other liquids to pass through, for example water.

Processes for making films or microporous membranes described herein can be broadly divided into wet and dry processes. Wet processes generally involve mixing hydrocarbon liquid or another low molecular weight substance with a polyolefin resin, heating and melting the mixture, extruding the melt into a sheet, orienting the sheet in the machine direction (MD), transverse direction (TD), and/or biaxially, and then extracting the liquid with a solvent. Dry processes generally involve melting a polyolefin resin, extruding it into a film or sheet, thermally annealing the extruded film, and subsequently orienting the sheet, in for instance the MD, TD, and/or biaxially at increased or high temperatures to form micropores. Accordingly, a microporous membrane, for instance formed into an oil absorbing device can be a dry-process microporous film or a wet process microporous film. It will be appreciated that a dry-process microporous film would not incorporate a solvent and/or oil, and a wet-process microporous film may incorporate a solvent and/or oil.

In some embodiments, a microporous film, membrane, and/or substrate can be formed into an absorptive device, or otherwise incorporated into an absorptive device and can have one or more advantages over conventional absorptive devices, for example improved absorptive and pass through properties as well as structural properties. In some embodiments, for example, the absorptive characteristics of a microporous film or membrane described herein can be tuned or enhanced by altering one or more structural properties including, but not limited to, material, film porosity, pore size, thickness, ribbing and/or patterning on one or more surfaces of the film or membrane, among others.

In some instances, a microporous film or membrane as described herein can be formed into a plurality of granules which can absorb one or more liquids or mixtures of liquids, for instance oils (soluble and insoluble), acids, paints, inks, and others.

Accordingly, a microporous membrane as described herein can be formed into an absorption device and configured to absorb a liquid, for example an oil, such as petroleum oil, engine oil, bodily oil, edible oil, etc.

A film (e.g. thin film) or microporous membrane as described herein can comprise one or more layers of a polyolefin, a fluorocarbon, a polyamide, a polyester, a polyacetal (or a polyoxymethylene), a polysulfide, a polyvinyl alcohol, a polyvinylidene, co-polymers thereof, block co-polymers thereof, or combinations thereof.

In some embodiments, a film or microporous membrane described herein comprises a polyolefin (PO) such as a polypropylene (PP) or a polyethylene (PE), a blend of polyolefins, one or more co-polymers of a polyolefin, block co-polymers of PE and PP, or a combination of any of the foregoing.

In some embodiments, a film or microporous membrane described herein comprises a filled or un-filled polymer membrane, dry process membrane, particle stretch membrane, biaxially oriented polypropylene (BOPP) membrane, beta-nucleated biaxially oriented polypropylene (BNBOPP) membrane, or wet process membrane of polyolefin (PO) such as a polypropylene (PP) or a polyethylene (PE), a blend of polyolefins, one or more co-polymers of a polyolefin, block co-polymers of PE and PP, or a combination of any of the foregoing.

It will be appreciated that a polyolefin as used in accordance with the present technology can be of any molecular weight not inconsistent with the characteristics of the microporous membranes or films described herein.

In some embodiments, a polyolefin can be an ultra-low molecular weight, a low-molecular weight, a medium molecular weight, a high molecular weight, or an ultra-high molecular weight polyolefin, such as a medium or a high weight polyethylene (PE) or polypropylene (PP). For example, an ultra-high molecular weight polyolefin can have a molecular weight of 450,000 (450 k) or above, e.g. 500 k or above, 650 k or above, 700 k or above, 800 k or above, 1 million or above, 2 million or above, 3 million or above, 4 million or above, 5 million or above, 6 million or above, and so on. A high-molecular weight polyolefin can have a molecular weight in the range of 250 k to 450 k, such as 250 k to 400 k, 250 k to 350 k, or 250 k to 300 k. A medium molecular weight polyolefin can have a molecular weight from 150 to 250 k, such as 100 k, 125 k, 130K, 140 k, 150 k to 225 k, 150 k to 200 k, 150 k to 200 k, and so on. A low molecular weight polyolefin can have a molecular weight in the range of 100 k to 150 k, such as 100 k to 125 k. An ultra-low molecular weight polyolefin can have a molecular weight less than 100 k. The foregoing values are weight average molecular weights. In some embodiments, a higher molecular weight polyolefin can be used to increase strength or other properties of the porous membrane. In some embodiments, a lower molecular weight polymer, such as a medium, low, or ultra-low molecular weight polymer can be beneficial. For example, without wishing to be bound by any particular theory, it is believed that the crystallization behavior of lower molecular weight polyolefins can result in a porous membrane having smaller pores resulting from at least an MD stretching process that forms the pores.

Fluorocarbons can comprise polytetrafluoroethylene (PTFE), polychlorotrifluoroethylene (PCTFE), fluorinated ethylene propylene (FEP), ethylenechlortrifluoroethylene (ECTFE), ethylene tetrafluoroethylene (ETFE), polyvinylidene fluoride (PVDF), polyvinylfluoride (PVF), prefluoroalkoxy (PFA) resin, co-polymers thereof, or combinations thereof. Polyamides can comprise, but are not limited to: polyamide 6, polyamide 6/6, Nylon 10/10, polyphthalamide (PPA), co-polymers thereof, or combinations thereof. Polyesters can comprise polyester terephthalate (PET), polybutylene terephthalate (PBT), poly-1-4-cyclohexylenedimethylene terephthalate (PCT), polyethylene naphthalate (PEN), or liquid crystal polymers (LCP). Polysulfides can comprise, but are not limited to, polyphenylsulfide, polyethylene sulfide, co-polymers thereof, or combinations thereof. Polyvinyl alcohols can comprise, but are not limited to, ethylenevinyl alcohol, co-polymers thereof, or combinations thereof. Polyvinylidenes include, but are not limited to: fluorinated polyvinylidenes (such as polyvinylidene chloride, polyvinylidene fluoride), copolymers thereof, and blends thereof.

A microporous membrane or film can in some instances comprise a semi-crystalline polymer, such as polymers having a crystallinity in the range of 20 to 80%.

In some embodiments, a microporous membrane or film described herein can have a structure of a single layer, a bi-layer, a tri-layer, or multilayers. For example, a tri-layer or multilayer membrane can comprise two outer layers and one or more inner layers. In some instances, microporous membrane can comprise 1, 2, 3, 4, 5, or more inner layers. In some other instances, each of the layers can be coextruded and/or laminated together.

Accordingly, a microporous membrane or film can be made by a dry stretch process in which one or more polymers are extruded to form the membrane. Each of the outer and inner layers can be mono-extruded, where the layer is extruded by itself, without any sublayers (plies), or each layer can comprise a plurality of co-extruded sublayers. For example, each layer can comprise a plurality of sublayers, such as a co-extruded bi-sublayer, tri-sublayer, or multi-sublayer membrane, each of which can collectively considered to be a “layer”. The number of sublayers in coextruded bi-layer is two, the number of layers in a co-extruded tri-layer is three, and the number of layers in a co-extruded multi-layer membrane will be two or more, three or more, four or more, five or more, and so on. The exact number of sublayers in a co-extruded layer is dictated by the die design and not necessarily the materials that are co-extruded to form the co-extruded layer. For example, a co-extruded bi-, tri-, or multi-sublayer membrane can be formed using the same material in each of the two, three, or four or more sublayers, and these sublayers will still be considered to be separate sublayers even though each sublayer is made of the same material.

In some embodiments, a tri-layer or multilayer microporous membrane described herein can comprise two outer layers (such as a first outer layer and a second outer layer) and a single or plurality of inner layers. The plurality of inner layers can be mono-extruded or co-extruded layers. A lamination barrier can be formed between each of the inner layers and/or between each of the outer layers and one of the inner layers. A lamination barrier can be formed when two surfaces, such as two surfaces of different membranes or layers are laminated together using heat, pressure, or heat and pressure.

In some embodiments, a microporous membrane or film as described herein can have any single layer, bi-layer, tri-layer, or multi-layer construction of PP and/or PE. In some embodiments, a microporous membrane described herein can have the following non-limiting constructions: PP, PE, PP/PP, PP/PE, PE/PP, PE/PE, PP/PP/PP, PP/PP/PE, PP/PE/PE. PP/PE/PP, PE/PP/PE, PE/PE/PP, PP/PP/PP/PP, PP/PE/PE/PP, PE/PP/PP/PE, PP/PE/PP/PP, PE/PE/PP/PP, PE/PP/PE/PP, PP/PE/PE/PE/PP, PE/PP/PP/PP/PE, PP/PP/PE/PP/PP, PE/PE/PP/PP/PE/PE, PP/PE/PP/PE/PP, PP/PP/PE/PE/PP/PP, PE/PE/PP/PP/PE/PE, PE/PP/PE/PP/PE/PP, PP/PE/PP/PE/PP/PE, PP/PP/PP/PE/PP/PP/PP, PE/PE/PE/PP/PE/PE/PE, PP/PE/PP/PE/PP/PE/PP, PE/PP/PE/PP/PE/PP/PE, PE/PP/PE/PP/PE/PP/PE/PP, PP/PE/PP/PE/PP/PE/PP/PE, PP/PP/PE/PE/PP/PP/PE/PE, PP/PE/PE/PE/PE/PE/PE/PP, PE/PP/PP/PP/PP/PP/PP/PE, PP/PP/PE/PE/PEPE/PP/PP, PP/PP/PP/PP/PE/PE/PE/PE, PP/PP/PP/PP/PE/PP/PP/PP/PP, PE/PE/PE/PE/PP/PE/PE/PE/PE, PP/PE/PP/PE/PP/PE/PP/PE/PP, PE/PP/PE/PP/PE/PP/PE/PP/PE, PE/PE/PE/PE/PE/PP/PP/PP/PP, PP/PP/PP/PP/PP/PE/PE/PE/PE, PP/PP/PP/PP/PP/PE/PE/PE/PE/PE, PE/PE/PE/PE/PE/PP/PP/PP/PP/PP, PP/PE/PP/PE/PP/PE/PP/PE/PP/PE, PE/PP/PE/PP/PE/PP/PE/PP/PE/PP, PE/PP/PP/PP/PP/PP/PP/PP/PP/PP/PE, PP/PE/PE/PE/PE/PE/PE/PE/PE/PE/PP, PP/PP/PE/PE/PP/PP/PE/PE/PP/PP, PE/PE/PP/PP/PP/PP/PP/PP/PP/PE/PE, PP/PP/PP/PE/PE/PP/PP/PP/PP/PE, or PE/PE/PE/PP/PP/PE/PE/PE/PP/PP. For purposes of reference herein PE denotes a single layer within the multilayer membrane that comprises PE. Similarly, PP denotes a single layer within the multilayer membrane that comprises PP. Thus, a PP/PE designation would represent a bi-layer membrane having a polypropylene (PP) layer and a polyethylene (PE) layer.

Individual layers in a film or microporous membrane can comprise a plurality of sublayers, which can be formed by co-extrusion or combining the individual sublayers to form the individual layer of the multilayer membrane. Using a multilayer membrane having a structure of PP/PE/PP, each individual PP or PE layer can comprise two or more co-extruded sublayers. For example, when each individual PP or PE layer comprises three sublayers, each individual PP layer can be expressed as PP=(PP1,PP2,PP3) and each individual PE layer can be expressed as PE=(PE1,PE2,PE3). Thus, the structure of PP/PE/PP can be expressed as (PP1,PP2,PP3)/(PE1,PE2,PE3)/(PP1,PP2,PP3). The composition of each of the PP1, PP2, and PP3 sublayers can be the same, or each sublayer can have a different polypropylene composition than one or both of the other polypropylene sublayers. Similarly, composition of each of the PE1, PE2, and PE3 sublayers can be the same, or each sublayer can have a different polyethylene composition than one or both of the other polyethylene sublayers. This principle applies to other multilayer membranes having more or less layers that the above-described exemplary tri-layer membrane.

In some embodiments, a microporous membrane or film described herein has an overall thickness of 1 micron to 60 microns, 1 micron to 55 microns, 1 micron to 50 microns, 1 micron to 45 microns, 1 micron to 40 microns, 1 micron to 35 microns, 1 micron to 30 microns, 1 micron to 25 microns, 1 micron to 20 microns, 1 micron to 15 microns, 1 micron to 10 microns, 5 microns to 50 microns, 5 microns to 40 microns, 5 microns to 30 microns, 5 microns to 25 microns, 5 microns to 20 microns, 5 microns to 10 microns, 10 microns to 40 microns, 10 microns to 35 microns, 10 microns to 30 microns, or 10 microns to 20 microns.

In some embodiments, each layer in bi-layer, tri-layer, or multi-layer microporous membrane or film can have a thickness equal to a thickness of the other layers, or have a thickness that is less than or greater than a thickness of the other layers. For example, when a microporous membrane is a tri-layer membrane comprising a structure of PP/PE/PP or PE/PP/PE, the polypropylene layers can have a thickness equal to a thickness of the polyethylene layer(s), have a thickness less than a thickness of the polyethylene layer(s), or have a thickness greater than a thickness of the polyethylene layer(s).

In some embodiments, a microporous membrane described herein can be a tri-layer laminated PP/PE/PP (polypropylene/polyethylene/polypropylene) or a PE/PP/PE (polyethylene/polypropylene/polyethylene) microporous membrane. In some instances, a structure ratio of the layers of the microporous membrane can comprise 45/10/45%, 40/20/40%, 39/22/39%, 38/24/38%, 37/26/37%, 36/28/36%, 35/30/35%, 34.5/31/34.5%, 34/32/34%, 33.5/33/33.5%, 33/34/33%, 32.5/35/32.5%, 32/36/32%, 31.5/37/31.5%, 31/38/31%, 30.5/39/30.5%, 30/40/30%, 29.5/41/29.5%, 29/42/29%, 28.5/43/28.5%, 28/44/28%, 27.5/45/27.5%, or 27/46/27%.

A microporous membrane described herein can additionally comprise fillers, elastomers, wetting agents, lubricants, flame retardants, nucleating agents, and other additional elements not inconsistent with the objectives of this disclosure. For example, the membrane can comprise fillers such as calcium carbonate, zinc oxide, diatomaceous earth, talc, kaolin, synthetic silica, mica, clay, boron nitride, silicon dioxide, titanium dioxide, barium sulfate, aluminum hydroxide, magnesium hydroxide and the like, or combinations thereof. Elastomers can comprise ethylene-propylene (EPR), ethylene-propylene-diene (EPDM), styrene-butadiene (SBR), styrene isoprene (SIR), ethylidene norbornene (ENB), epoxy, and polyurethane or combinations thereof. Wetting agents can comprise ethoxylated alcohols, primary polymeric carboxylic acids, glycols (such as polypropylene glycol and polyethylene glycols), functionalized polyolefins, and the like. Lubricants can comprise a silicone, a fluoropolymer, oleamide, stearamide, erucamide, calcium stearate, or other metallic stearates. Flame retardants can comprise brominated flame retardants, ammonium phosphate, ammonium hydroxide, alumina trihydrate, and phosphate ester.

A microporous membrane or film described in some of the embodiments herein, can in some instances, be made by a dry-stretch process. A microporous membrane is understood to be a thin, pliable, polymeric sheet, foil, or membrane having a plurality of pores extending therethrough. In some cases, the porous membrane is made by the dry-stretch process, which refers to a process where pore formation results from stretching a nonporous, semicrystalline, extruded polymer precursor in the machine direction (MD), transverse direction (TD), or in both an MD and TD (i.e. biaxially). Such a dry-stretch process is different from the wet process and the particle stretch process. Generally, in the wet process, also known as a phase inversion process, an extraction process, or a TIPS process, a polymeric raw material is mixed with a processing oil (sometimes referred to as a plasticizer), this mixture is extruded, and pores are formed when the processing oil is removed. While these wet process membranes may be stretched before or after the removal of the oil, the principle pore formation mechanism is the use of the processing oil.

A porous membrane can be a macroporous membrane, a mesoporous membrane, a microporous membrane, or a nanoporous membrane. The porosity of the membrane can be any porosity not inconsistent with the goals of this disclosure. In some embodiments, the porosity of the porous substrate is from 10 to 95%, from 20 to 90%, from 20 to 80%, from 40 to 80%, from 20 to 70%, from 40 to 70%, from 40-60%, more than 10%, more than 20%, more than 30%, or more than 40%. Porosity is measured using ASTM D-2873 and is defined as the percentage of void space, e.g., pores, in an area of the porous substrate, measured in the Machine Direction (MD) and the Transverse Direction (TD) of the substrate. In some embodiments, the pores are round with a sphericity factor of 0.25 to 8.0, or are oblong, or are oval-shaped.

A microporous membrane can have any Gurley not inconsistent with the objectives of this disclosure, such as a Gurly that is acceptable for use as an absorptive device. Gurley is the Japanese Industrial Standard (JIS Gurley) and can be measured using a permeability tester, such as an OHKEN permeability tester. JIS Gurley is defined as the time in seconds required for 100 cc of air to pass through one square inch of membrane at a constant pressure of 4.9 inches of water. In some embodiments, the porous film or membrane described herein has a JIS Gurley (s/100 cc) of 150 or more, 160 or more, 170 or more, 180 or more, 190 or more, 200 or more, 210 or more, 220 or more, 230 or more, 240 or more, 250 or more, 260 or more, 270 or more, 280 or more, 290 or more, 300 or more, 310 or more, 320 or more, 330 or more, 340 or more, 350 or more, 100 to 800, 200 to 700, 200 to 600, 200 to 500, 200 to 400, 200 to 300, or 300 to 600.

A microporous membrane can have a puncture strength, uncoated, of 200 gf or more, 210 gf or more, 220 gf or more, 230 gf or more, 240 gf or more, 250 gf or more, 260 gf or more, 270 gf or more, 280 gf or more, 290 gf or more, 300 gf or more, 310 gf or more, 320 gf or more, 330 gf or more, 340 gf or more, 350 gf or more, or as high as 400 gf or more.

In some embodiments, a microporous membrane described herein can comprise one or more additives in at least one layer of the porous membrane. In some embodiments, at least one layer of a porous membrane comprises more than one, such as two, three, four, five, or more, additives. Additives can be present in one or both of the outermost layers of the porous membrane, in one or more inner layers, in all of the inner layers, or in all of the inner and both of the outermost layers. In some embodiments, additives can be present in one or more outermost layers and in one or more innermost layers. In such embodiments, over time, an additive can be released from the outermost layer or layers and the additive supply of the outermost layer or layers can be replenished by migration of the additive in the inner layers to the outermost layers. In some embodiments, each layer of a microporous membrane can comprise a different additive or combination of additives than an adjacent layer of the microporous membrane.

In some embodiments, an additive comprises a functionalized polymer. It will be appreciated that a functionalized polymer is a polymer with functional groups coming off of the polymeric backbone. In some embodiments, the functionalized polymer is a maleic anhydride functionalized polymer. In some further embodiments the maleic anhydride modified polymer is a maleic anhydride homo-polymer polypropylene, copolymer polypropylene, high density polypropylene, low-density polypropylene, ultra-high density polypropylene, ultra-low density polypropylene, homo-polymer polyethylene, copolymer polyethylene, high density polyethylene, low-density polyethylene, ultra-high density polyethylene, and/or ultra-low density polyethylene.

In some embodiments, an additive comprises an ionomer. An ionomer, as understood by one of ordinary skill in the art is a copolymer containing both ion-containing and non-ionic repeating groups. Sometimes the ion-containing repeating groups can make up less than 25%, less than 20%, or less than 15% of the ionomer. In some embodiments, the ionomer can be a Li-based, Na-based, or Zn-based ionomer. In some embodiments, an additive comprises cellulose nanofiber.

In some embodiments, an additive comprises inorganic particles having a narrow size distribution. For example, the difference between D10 and D90 in a distribution is less than 100 nanometers, less than 90 nanometers, less than 80 nanometers, less than 70 nanometers, less than 60 nanometers, less than 50 nanometers, less than 40 nanometers, less than 30 nanometers, less than 20 nanometers, or less than 10 nanometers. In some embodiments, the inorganic particles are selected from at least one of SiO₂, TiO₂, or combinations thereof.

In some embodiments, an additive comprises a lubricating agent. A lubricating agent or lubricant described herein can be any lubricating agent not inconsistent with the objectives of this disclosure. As understood by one of ordinary skill in the art, a lubricant is a compound that acts to reduce the frictional force between a variety of different surfaces, including the following: polymer:polymer; polymer:metal; polymer:organic material; and polymer:inorganic material. Specific examples of lubricating agents or lubricants as described herein are compounds comprising siloxy functional groups, including siloxanes and polysiloxanes, and fatty acid salts, including metal stearates.

Compounds comprising two or more, three or more, four or more, five or more, six or more, seven or more, eight or more, nine or more, or ten or more siloxy groups can be used as the lubricant described herein. Siloxanes, as understood by those in the art, are a class of molecules with a backbone of alternating silicon atom (Si) and oxygen (O) atoms, each silicon atom can have a connecting hydrogen (H) or a saturated or unsaturated organic group, such as —CH3 or C2H5. Polysiloxanes are a polymerized siloxanes, usually having a higher molecular weight. In some embodiments described herein, the polysiloxanes can be high molecular weight, such as ultra-high molecular weight polysiloxanes. In some embodiments, high and ultra-high molecular weight polysiloxanes can have weight average molecular weights ranging from 500,000 to 1,000,000.

A fatty acid salt described herein can be any fatty acid salt not inconsistent with the objectives of this disclosure. In some instances, a fatty acid salt can be any fatty acid salt that acts as a lubricant. The fatty acid of the fatty acid salt can be a fatty acid having between 12 to 22 carbon atoms. For example, the metal fatty acid can be selected from the group consisting of: Lauric acid, myristic acid, palmitic acid, stearic acid, oleic acid, linoleic acid, linolenic acid, palmitoleic acid, behenic acid, erucic acid, and arachidic acid. The metal can be any metal not inconsistent with the objectives of this disclosure. In some instances, the metal is an alkaline or alkaline earth metal, such as Li, Be, Na, Mg, K, Ca, Rb, Sr, Cs, Ba, Fr, and Ra. In some embodiments, the metal is Li, Be, Na, Mg, K, or Ca. In some instances a fatty acid salt can be lithium stearate, sodium stearate, lithium oleate, sodium oleate, sodium palmitate, lithium palmitate, potassium stearate, or potassium oleate.

A lubricant, including the fatty acid salts described herein, can have a melting point of 200° C. or above, 210° C. or above, 220° C. or above, 230° C. or above, or 240° C. or above. A fatty acid salt such as lithium stearate (melting point of 220° C.) or sodium stearate (melting point 245 to 255° C.) has such a melting point.

In some embodiments, an additive can comprise one or more nucleating agents. As understood by one of ordinary skill in the art, nucleating agents are, in some embodiments, materials, inorganic materials, that assist in, increase, or enhance crystallization of polymers, including semi-crystalline polymers.

In some embodiments, an additive can comprise a cavitation promoter. Cavitation promoters, as understood by those skilled in the art, are materials that form, assist in formation of, increase formation of, or enhance the formation of bubbles or voids in the polymer. In some embodiments, an additive can comprise a fluoropolymer, such as the fluoropolymers discussed in detail herein. In some embodiments, an additive can comprise a cross-linker.

In some embodiments, an additive can comprise an x-ray detectable material. An x-ray detectable material can be any x-ray detectable material not inconsistent with the objectives of this disclosure. Suitable amounts of the x-ray detectable material or element include, for example, up to 50 weight %, up to 40 weight %, up to 30 weight %, up to 20 weight %, up to 10 weight %, up to 5 weight %, or up to 1 weight % based on the total weight of the porous film or membrane can be used. In an embodiment, the additive is barium sulfate.

In some embodiments, an additive can comprise a lithium halide. The lithium halide can be lithium chloride, lithium fluoride, lithium bromide, or lithium iodide. The lithium halide can be lithium iodide, which is both ionically conductive and electrically insulative. In some instances, a material that is both ionically conductive and electrically insulative can be used as part of a membrane.

In some embodiments, an additive can comprise a polymer processing agent. As understood by those skilled in the art, polymer processing agents or additives are added to improve processing efficiency and quality of polymeric compounds. In some embodiments, the polymer processing agent can be antioxidants, stabilizers, lubricants, processing aids, nucleating agents, colorants, antistatic agents, plasticizers, or fillers.

In some embodiments, an additive can comprise high temperature melt index (HTMI) polymer. The HTMI polymer can be any HTMI polymer not inconsistent with the objectives of this disclosure. In some instances, the HTMI polymer can be at least one selected from the group consisting of PMP, PMMA, PET, PVDF, Aramid, syndiotactic polystyrene, and combinations thereof.

In some embodiments, an additive can comprise an electrolyte, a flame-retardant additive, a wetting agent, and a viscosity improver, amongst others.

A film or microporous membrane described herein can be MD stretched or TD stretched to make the membrane porous. In some instances, the microporous membrane is produced by sequentially performing a TD stretch of an MD stretched microporous membrane, or by sequentially performing an MD stretch of a TD stretched microporous membrane. In addition to a sequential MD-TD stretching, the microporous membrane can also simultaneously undergo a biaxial MD-TD stretching. Moreover, the simultaneous or sequential MD-TD stretched porous membrane can be followed by a subsequent calendering step to reduce the membrane's thickness, reduce roughness, reduce percent porosity, increase TD tensile strength, increase uniformity, and/or reduce TD splittiness.

In some embodiments, a microporous membrane can comprise pores having an average pore size of 0.01 micron to 1 micron, 0.02 micron to 1 micron, 0.03 micron to 1 micron, 0.04 micron to 1 micron, 0.05 micron to 1 micron, 0.06 micron to 1 micron, 0.07 micron to 1 micron, 0.08 micron to 1 micron, 0.09 micron to 1 micron, 0.1 micron to 1 micron, 0.2 micron to 1 micron, 0.3 micron to 1 micron, 0.4 micron to 1 micron, 0.5 micron to 1 micron, 0.6 micron to 1 micron, 0.7 micron to 1 micron, 0.8 micron to 1 micron, 0.9 micron to 1 micron, 0.01 micron to 0.9 micron, 0.01 micron to 0.8 micron, 0.01 micron to 0.7 micron, 0.01 micron to 0.6 micron, 0.01 micron to 0.5 micron, 0.01 micron to 0.4 micron, 0.01 micron to 0.3 micron, 0.01 micron to 0.2 micron, 0.01 micron to 0.1 micron, 0.01 micron to 0.09 micron, 0.01 micron to 0.08 micron, 0.01 micron to 0.07 micron, 0.01 micron to 0.06 micron, 0.01 micron to 0.05 micron, 0.01 micron to 0.04 micron, 0.01 micron to 0.03 micron, 1 micron, 0.9 micron, 0.8 micron, 0.7 micron, 0.6 micron, 0.5 micron, 0.4 micron, 0.3 micron, 0.2 micron, 0.1 micron, 0.09 micron, 0.08 micron, 0.07 micron, 0.06 micron, 0.05 micron, 0.04 micron, 0.03 micron, 0.02 micron, or 0.01 micron.

In an embodiment, a porous (or microporous) membrane or film (e.g. thin film) can be manufactured using an exemplary process that includes stretching and a subsequent calendering step such as a machine direction stretching followed by transverse direction stretching (with or without machine direction relax) and a subsequent calendering step as a method of reducing the thickness of such a stretched membrane, for example, a multilayer porous membrane, in a controlled manner, to reduce the percent porosity of such a stretched membrane, for example, a multilayer porous membrane, in a controlled manner, and/or to improve the strength, properties, and/or performance of such a stretched membrane, for example, a multilayer porous membrane, in a controlled manner, such as the puncture strength, machine direction and/or transverse direction tensile strength, uniformity, wettability, coatability, runnability, compression, spring back, tortuosity, permeability, thickness, pin removal force, mechanical strength, surface roughness, hot tip hole propagation, and/or combinations thereof, of such a stretched membrane, for example, a multilayer porous membrane, in a controlled manner, and/or to produce a unique structure, pore structure, material, membrane, base membrane, or film.

In some instances, the TD tensile strength of the multilayer membrane can be further improved by the addition of a calendering step following TD stretching. The calendering process typically involves heat and pressure that can reduce the thickness of a porous membrane. The calendering process step can recover the loss of MD and TD tensile strength caused by TD stretching. Furthermore, the increase observed in MD and TD tensile strength with calendering can create a more balanced ratio of MD and TD tensile strength which can be beneficial to the overall mechanical performance of the multilayer membrane.

The calendering process can use uniform or non-uniform heat, pressure and/or speed to selectively densify a heat sensitive material, to provide a uniform or non-uniform calender condition (such as by use of a smooth roll, rough roll, patterned roll, micro pattern roll, nano pattern roll, speed change, temperature change, pressure change, humidity change, double roll step, multiple roll step, or combinations thereof), to produce improved, desired or unique structures, characteristics, and/or performance, to produce or control the resultant structures, characteristics, and/or performance, and/or the like. In an embodiment, a calendering temperature of 50° C. to 70° C. and a line speed of 40 to 80 ft/min can be used, with a calendering pressure of 50 to 200 psi. The higher pressure can in some instances provide a thinner film, and the lower pressure provide a thicker film.

In some embodiments, one or more coating layers can be applied to one or two sides of the multilayer membrane. In some embodiments, one or more of the coatings can be a ceramic coating comprising a polymeric binder and organic and/or inorganic particles. In some embodiments, only a ceramic coating is applied to one or both sides of the microporous membrane. In other embodiments, a different coating can be applied to the microporous membrane before or after the application of the ceramic coating. The different additional coating can be applied to one or both sides of the membrane or film also. In some embodiments, the different polymeric coating layer can comprise at least one of polyvinylidene difluoride (PVdF) or polycarbonate (PC).

In some embodiments, the thickness of the coating layer is less than about 12 μm, sometimes less than 10 μm, sometimes less than 9 μm, sometimes less than 8 μm, sometimes less than 7 μm, and sometimes less than 5 μm. In at least certain selected embodiments, the coating layer is less than 4 μm, less than 2 μm, or less than 1 μm.

The coating method is not so limited, and the coating layer described herein can be coated onto a porous substrate by at least one of the following coating methods: extrusion coating, roll coating, gravure coating, printing, knife coating, air-knife coating, spray coating, dip coating, or curtain coating. The coating process can be conducted at room temperature or at elevated temperatures.

The coating layer can be any one of nonporous, nanoporous, microporous, mesoporous or macroporous. The coating layer can have a JIS Gurley of 700 or less, sometimes 600 or less, 500 or less, 400 or less, 300 or less, 200 or less, or 100 or less.

In some embodiments, a microporous membrane or thin film can comprise one or more layers of a polyolefin and can be configured to absorb a liquid, for example an oil. As described herein, the microporous membrane can be a dry-process microporous film or a wet-process microporous film. In addition to a polyolefin, a microporous membrane or film may further incorporate additional materials such as a filler, for example a siliceous filler, and/or plasticizing agent, for example an oil. In some instances, the plasticizing agent can be present in an amount of 25% or less, 20% or less, 15% or less, 10% or less, or 5% or less of the overall composition. In some other instances the filler can be a hydrophobic siliceous filler, a hydrophilic siliceous filler, or a combination of fillers.

In some embodiments, a microporous membrane or film as described herein can be formed of scrap polyolefin microporous film, which can be, for example, sheets, particulates, pieces, or strips. The microporous membrane or film can be formed into a sheet, a strip, a roll, amongst others, and can further be embossed, include one or more ribs, and/or incorporate one or more patterns one a surface of any one of the layers of the microporous membrane or film. As will be appreciated, incorporating various structural and design elements, such as those described here, can in some instances increase the surface area of the membrane or film (and as such a device formed from a microporous membrane described here, and enable greater absorption (e.g. oil absorption) and improved collection capabilities.

As described herein, in some instances, a microporous membrane can absorb and hold oil or oil based liquids and additionally (in some cases simultaneously) allow other liquids, such as water, to pass through the microporous membrane. It will be appreciated that various structural parameters of a microporous membrane may be tuned to different liquids. In some instances, the microporous membrane or film can include one or more ribs on one or more surfaces of the microporous membrane which can extend all or partially across a dimension of the microporous membrane. As will be appreciated, one or more ribs can allow for spacing between multiple films when incorporated into a device, for instance in a roll or a stack. Further, the incorporation of a rib structure can allow for movement of a liquid, such as water, down or through the membrane or film, while another liquid, such as oil, can be collected by the one or more ribs. Additionally, ribs can add surface area for absorption and adsorption in instances where a siliceous filler is used. In some instances, a microporous membrane or film can absorb at least 1× its weight in an oil.

According to various embodiments, structural parameters of a microporous membrane or film can be tuned to achieve various applications of a device described herein. In some instances, a microporous membrane can have an overall thickness from about 10 microns to about 1,0000 microns. In some instances, the overall thickness of a microporous membrane or film includes rib height. The microporous membrane can further have a porosity from about 10% to about 95% and pore sizes from about 0.01 micron to about 1 micron.

The microporous membrane or film can have any composition and/or properties described herein, can absorb and adsorb oil, and further can have an oil absorption of more than 20 g/m² when the oil to be absorbed is petroleum oil. This product may be configured to repel water. For example, a surface of a microporous membrane may exhibit a contact angle with water greater than 90° and less than 180°.

The microporous membrane or film may be acid resistant as this product may be used typically in a sulfuric acid battery electrolyte. The acid resistance of the microporous membrane being measured using the residual puncture after a 72-hour soak in room temperature (˜21° C.) 1.8 specific gravity concentrated sulfuric acid washing in water and drying in the oven at 110° C. for 10 minutes. Puncture is measured using BCIS-03B Puncture Resistance with Chatillon Tester (Motorized) and the % Residual is >75% and calculated using the following formula:

$$\% Residual = {Puncture}_{Final} / {Puncture}_{Initial} \times 100.$$

Devices incorporating a microporous membrane or film described herein can be a contaminant boom for containing oil present in or on water. Devices incorporating such microporous membrane's or films can, for example, be a sorbent boom, pillow, mat, or roll to remove, absorb, and/or adsorb oil present in or on water. Further, devices for removing (or otherwise separating) oil from water can absorb and/or adsorb (or otherwise collect) oil into the microporous membrane and further such oil can be recovered from the device and/or microporous membrane. In some instances, oil may be removed (or recovered) from a device or microporous membrane by using compression or extraction. In some instances, extraction or recovery can be achieved through the use of solvents. After oil is recovered or extracted from a device or microporous membrane, the device or microporous membrane can be reused to absorb additional oil or can be recycled after use.

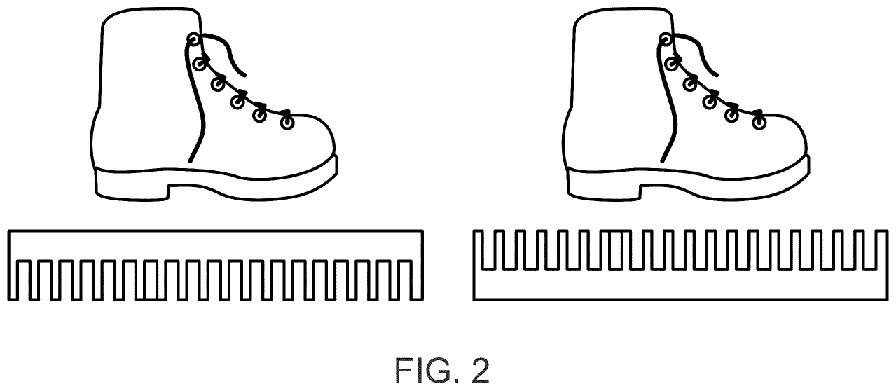

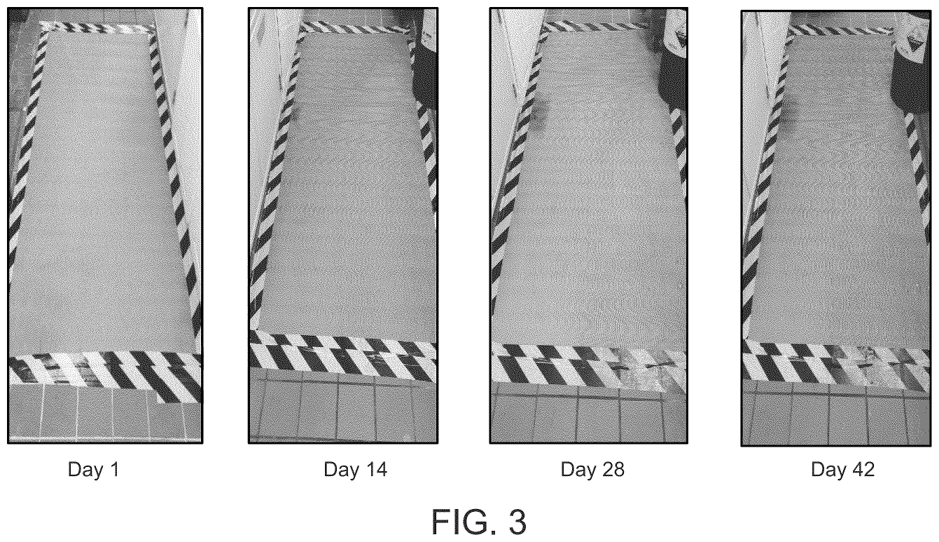

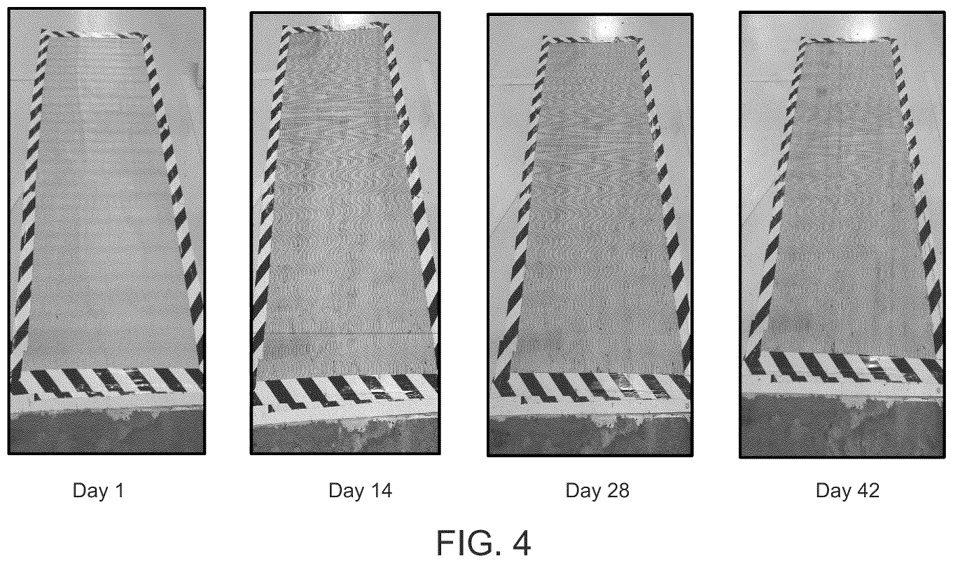

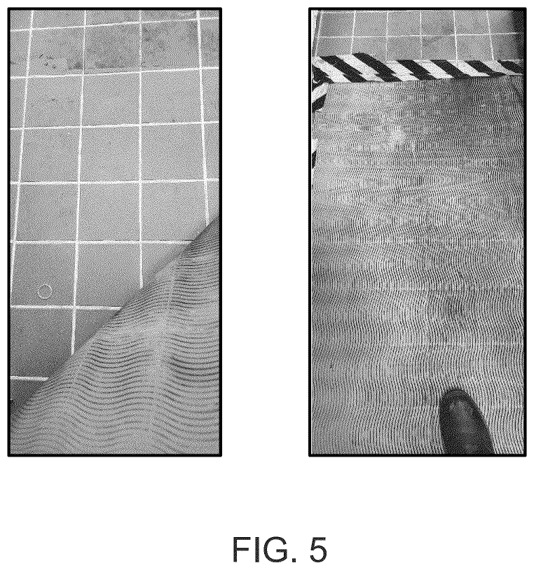

Devices incorporating microporous membranes or films described herein can be configured as a floor covering or a mat or components thereof. A floor covering or mat can be non-slip or non-skid, can be anti-fatigue, anti-static, and can further be dirt or soil removing (e.g. via ribs or bristles). As will be appreciated, various structural properties of a device or microporous membrane, such as one or more ribs or other features can provide such properties as depicted for example in FIG. 2 and FIG. 4. As some of the these membranes described herein are resistant to most acids, devices incorporating the microporous membranes or films are well suited for use in a laboratory setting as depicted in FIG. 3 and FIG. 5. In some further embodiments, a device incorporating a microporous membrane or film described herein can be patterned, printed or painted on prior to or after lamination of layers (e.g. company logo). In some further embodiments, a device incorporating a microporous membrane or film described herein can be configured as a drawer liner. In yet some further embodiments, a device incorporating a microporous membrane or film described herein can be configured or formed as a wipe for removing oil from floors, walls, furniture, etc. Some devices incorporating the microporous membranes or films described herein may comprise both a wet process microporous film or membrane as described herein and a dry process microporous membrane or film described herein.

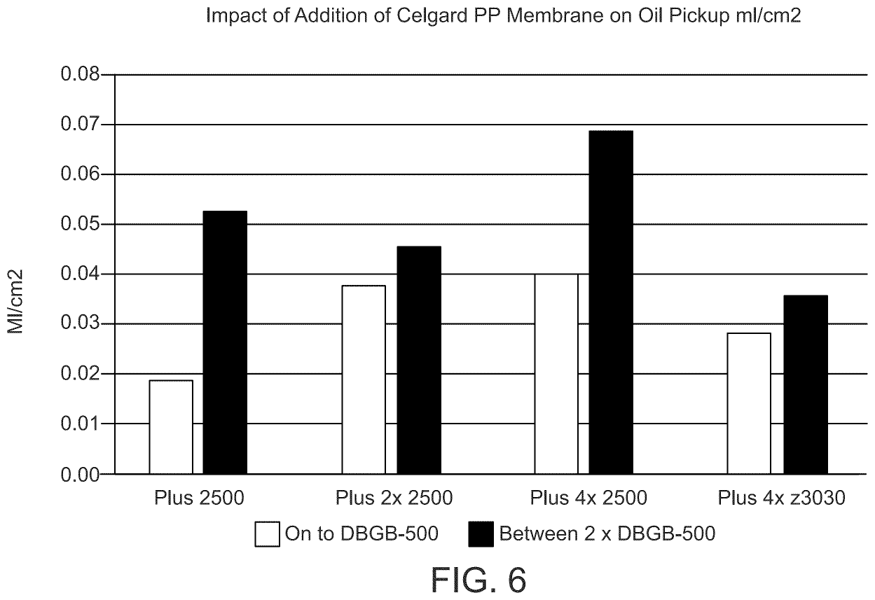

With reference to FIG. 6, water repellency or oil absorption may be enhanced or improved by adding one or more microporous dry process PP membranes or films (such as a Celgard® 2500 25 μm MD stretched polypropylene (PP) microporous membrane or a Celgard® Z3030 18 μm biax stretched polypropylene (PP) microporous membrane) over a microporous wet process PE membrane such as a microporous silica filled wet process PE membrane (such as a Daramic® 500 μm backweb ribbed silica filled PE membrane). Possibly preferred PP and/or PE membrane structures, composites or laminates may include: PE; PE/PE; PE/PE/PE; PE/PP; PE/PP/PP; PE/PP/PE; PE/PP/PP/PE; PE/PP/PP/PP/PE; PE/PP/PP/PP/PP/PE; PE/PP/PP/PP; PE/PP/PP/PP/PP; PP; PP/PP; PP/PP/PP; PP/PP/PP/PP; etc.

In accordance with other embodiments, mats or other absorption devices may be made of oil absorptive materials such as PP and/or PE membrane structures made of absorptive strips, slits, flat yarns, fibers, or hollow fibers, twisted yarns of absorptive strips, slits, flat yarns, fibers, or hollow fibers, and combinations thereof woven into woven pads, mats or rugs, formed into non-woven pads, mats or rugs, formed into spiral pads, mats or rugs, or the like.

In accordance with selected embodiments, aspects or objects, there may be provided absorption devices, materials, including films, thin films, and/or membranes, and more specifically to microporous membranes and devices having absorptive properties, especially oil absorbing devices and materials such as polyolefin membranes with or without silica fillers, and composite membranes such as dry process PP membranes and wet process PE silica filled membranes, and including a method of using the device, membrane or material comprising a contacting step where oil and the device are in contact, wherein the oil is contacted with the device, wherein the device is contacted with oil, comprising a step of providing the floor covering or floor mat onto a floor and leaving it on the floor for at least one day, wherein the floor covering or floor mat is left on the floor for at least one week, wherein the floor covering or floor mat is left on the floor for at least one month, and combinations thereof.

In accordance with selected embodiments, aspects or objects, there may be provided absorption devices, materials, and methods, including films, thin films, and/or membranes, and more specifically to microporous membranes and devices having absorptive properties, especially oil absorbing devices and materials such as polyolefin membranes with or without silica fillers, and composite membranes such as dry process PP membranes and wet process PE silica filled membranes.

In one aspect, embodiment or object, a device for absorbing a liquid is provided, the device comprising one or more layers of a polyolefin. The device may be configured as a microporous membrane comprising one or more layers of a polyolefin and can further be configured to absorb an oil while also allowing water to pass through or to absorb oil while repelling or not allowing water to pass through. The device may be configured as at least one of a sheet, a strip, a roll, pleated, embossed, ribbed, and/or patterned. The device may further be configured as a floor covering or mat. The device may further be configured as a modular floor covering or tile that may also be interlocking with other tiles.

Many different arrangements of the various components and/or steps depicted and described, as well as those not shown, are possible without departing from the scope of the claims below. Embodiments of the present technology have been described with the intent to be illustrative rather than restrictive. Alternative embodiments will become apparent from reference to this disclosure. Alternative means of implementing the aforementioned can be completed without departing from the scope of the claims below. Certain features and subcombinations are of utility and can be employed without reference to other features and subcombinations and are contemplated within the scope of the claims.

1. An absorption device comprising:
a microporous membrane comprising one or more layers of a polyolefin;
wherein the microporous membrane is configured to absorb an oil.

2. The device of claim 1, wherein the microporous membrane is at least one of: a dry-process microporous film, a wet process microporous film, or a filled microporous film comprising a polyolefin, a filler, and optionally a plasticizing agent.

3-45. (canceled)

46. The device of claim 2, wherein the filler is a siliceous filler and the plasticizing agent is an oil.

47. The device of claim 2, wherein the plasticizing agent is present in an amount of 25% or less.

48. The device of claim 3, wherein the filler is at least one of a hydrophobic siliceous filler, a hydrophilic siliceous filler, or combinations thereof.

49. The device of claim 1, wherein the microporous membrane is at least one of: a polyolefin microporous film which may be sheets, particulate, pieces, or strips; or, a sheet, a strip, a roll, pleated, embossed, ribbed, and patterned.

50. The device of claim 1, wherein at least one of the following: wherein the microporous membrane absorbs an oil and allows water to pass through; wherein the microporous membrane incorporates structural elements such as pleats, ribs, embossing, raised shapes, suction elements, embossing, and patterning; wherein the microporous membrane has an overall thickness from 10 microns to 1,000 microns; wherein the microporous membrane absorbs oil at an amount of at least 1× the membrane's weight; wherein the microporous membrane has a porosity from 10% to 95%; wherein the microporous membrane has an average pore size from 0.01 micron to 1.0 micron; wherein the microporous membrane has an oil absorption more than 20 g/m² when the oil is petroleum oil; or, wherein the microporous membrane absorbs and adsorbs oil.

51. The device of claim 1, wherein the device is at least one of a contaminant boom for containing oil that is in or on water, and a sorbent boom, pillow, mat, or roll configured to remove oil that is in or on water.

52. The device of claim 1, wherein an oil is recoverable from the microporous membrane.

53. The device of claim 9, wherein the oil is recoverable by at least one of compression and extraction.

54. The device of claim 1, wherein the microporous membrane can be reused after absorbing an oil or is recycled.

55. The device of claim 1, wherein the device is a floor covering or a mat or a component thereof.

56. The device of claim 12, wherein the floor covering or mat is at least one of non-slip or non-skid, anti-fatigue, anti-static, and dirt or soil removing.

57. The device of claim 1, wherein the device is a drawer liner or a wipe to remove oil from floors, walls, furniture, and the like.

58. The device of claim 1, wherein the microporous membrane absorbs an oil and repels water.

59. A method of using the device of claim 1, comprising a contacting step where oil and the device are in contact.

60. The method of claim 16, wherein the oil is contacted with the device.

61. The method of claim 16, wherein the device is contacted with oil.

62. A method of using the device of claim 12, comprising a step of providing the floor covering or floor mat onto a floor and leaving it on the floor for at least one day, for at least one week, or for at least one month.

63. The device of claim 1, wherein the microporous membrane is acid resistant meaning that the membrane has a residual puncture>75% when the membrane is subjected to 72-hour soak in 1.8 specific gravity sulfuric acid at 21° C., washed in water and dried in oven at 110° C.

64. The device of claim 1, wherein the microporous membrane repels water, a surface of the membrane having a contact angle with water that is greater than 90° and less than 180°.

65. An absorption device comprising at least one of:
a wet-process microporous membrane, and
a dry-process microporous membrane;
at least one wet-process microporous membrane, and
at least one dry-process microporous membrane;
a PE silica filled microporous membrane, and
a PP microporous membrane;
at least one PE microporous membrane, and
at least one PP microporous membrane; and
at least one PE porous membrane, and
at least one PP porous membrane.

66. A composite or laminate absorption device comprising:
a plurality of PE silica filled wet-process microporous membranes; and
a plurality of dry-process PO microporous membranes.

67. The device of claim 5, wherein the plasticizing agent is present in an amount of 25% or less.
